(19) United States
(12) Patent Application Publication
(10) Pub. No.: US 2015/0257380 A1
(43) Pub. Date: Sep. 17, 2015

(54) GLYPHOSATE ADJUVANT COMPOSITIONS AND METHODS OF MAKING AND USING THE SAME

(71) Applicant: Syngenta Participations AG, Basel (CH)

(72) Inventors: Colin Douglas MILN, Greensboro, NC (US); Henry AGBAJE, Greensboro, NC (US); Ian David TOVEY, Bracknell Berkshire (GB); Kirsty Jane WILLIAMS, Muenchwilen (CH)

(73) Assignee: SYNGENTA PARTICIPATIONS AG, Basel (CH)

(21) Appl. No.: 14/657,057

(22) Filed: Mar. 13, 2015

Related U.S. Application Data
(60) Provisional application No. 61/952,455, filed on Mar. 13, 2014.

(51) Int. Cl. A01N 25/30; A01N 57/20

(52) U.S. Cl. CPC A01N 25/30; A01N 57/20

(57) ABSTRACT

Glyphosate adjuvant compositions and methods of making and using the same are disclosed.

### RELATED APPLICATION INFORMATION

This application claims the benefit of the U.S. Provisional Application No. 61/952455, filed 13 Mar. 2014, the contents of which are incorporated herein by reference herein.

### TECHNICAL FIELD

The present invention relates to glyphosate adjuvant compositions and methods of making and using the same.

### BACKGROUND

Glyphosate adjuvant compositions comprising combinations of adjuvants are disclosed. For example, each of WO2000/015037, WO2009/154772 and U.S. Pat. No. 5,710,103 discuss glyphosate adjuvant compositions comprising a coco-amine ethoxylate, a tallow amine ethoxylate, or a combination of a coco-amine ethoxylate and a tallow amine ethoxylate. However, known glyphosate adjuvant compositions, including those disclosed in WO2000/015037, WO2009/154772 and U.S. Pat. No. 5,710,103, result in glyphosate compositions having one or more of the following shortcomings: (1) less than desirable rainfastness, (2) a relatively low cloud point, (3) less than desirable biological efficacy, and/or (4) less than desirable freeze-thaw properties.

There exists a need in the art for glyphosate adjuvant compositions that result in glyphosate compositions having one or more of: (1) improved rainfastness, (2) a relatively higher cloud point, (3) improved biological efficacy, and/or (4) improved freeze-thaw properties.

### SUMMARY

The present invention addresses the need in the art for glyphosate adjuvant compositions that result in glyphosate compositions having (1) improved rainfastness, (2) a relatively higher cloud point, (3) improved biological efficacy, and/or (4) improved freeze-thaw properties. In one exemplary embodiment, the present invention is directed to glyphosate adjuvant compositions comprising: a coco-amine ethoxylate in combination with a tallow amine ethoxylate, wherein the coco-amine ethoxylate and the tallow amine ethoxylate are present, in combination, at a combined weight percent (wt %) of at least 25 wt % based on a total weight of the glyphosate adjuvant composition and wherein the coco-amine ethoxylate to tallow amine ethoxylate ratio is from 1:4 to 4:1, from 1:2 to 2:1, from 2:3 to 3:2, or 1:1 or about 1:1. In some exemplary embodiments, the glyphosate adjuvant composition comprises a coco-amine ethoxylate in combination with a tallow amine ethoxylate, wherein the coco-amine ethoxylate and the tallow amine ethoxylate are present, in combination, at a combined weight percent of at least 50 wt % based on a total weight of the glyphosate adjuvant composition. The present invention also includes synthetic forms of coco and tallow amines. Such synthetic forms include, for example, Synprolam™ 35X15 from Croda International Plc. <www.croda.com>.

The present invention is further directed to glyphosate compositions comprising (i) any one of the herein disclosed glyphosate adjuvant compositions, and (ii) glyphosate or a glyphosate salt. In one exemplary embodiment, glyphosate compositions of the present invention comprise (i) a glyphosate adjuvant composition comprising: a coco-amine ethoxylate in combination with a tallow amine ethoxylate, wherein the coco-amine ethoxylate and the tallow amine ethoxylate are present, in combination, at a combined weight percent of at least 25 wt % based on a total weight of the glyphosate adjuvant composition, and (ii) glyphosate or a glyphosate salt (e.g., potassium glyphosate).

The present invention is even further directed to methods of making glyphosate adjuvant compositions and glyphosate compositions. In one exemplary embodiment, the method of making a glyphosate adjuvant composition comprises: combining a coco-amine ethoxylate with a tallow amine ethoxylate so that the combined weight percent of the coco-amine ethoxylate and the tallow amine ethoxylate is at least 25 wt % based on a total weight of the glyphosate adjuvant composition. In one exemplary embodiment, the method of making a glyphosate composition comprises: adding glyphosate or a glyphosate salt to the glyphosate adjuvant composition.

The present invention is even further directed to methods of improving the rainfastness of a glyphosate composition. In one exemplary embodiment, the method of improving the rainfastness of a glyphosate composition comprises: incorporating a glyphosate adjuvant composition into a glyphosate composition, the glyphosate adjuvant composition comprising a coco-amine ethoxylate in combination with a tallow amine ethoxylate, wherein the coco-amine ethoxylate and the tallow amine ethoxylate are present, in combination, at a combined weight percent of at least 25 wt % based on a total weight of the glyphosate adjuvant composition.

The present invention is also directed to methods of improving the cloud point of a glyphosate composition. In one exemplary embodiment, the method of improving the cloud point of a glyphosate composition comprises: incorporating a glyphosate adjuvant composition into a glyphosate composition, the glyphosate adjuvant composition comprising a coco-amine ethoxylate in combination with a tallow amine ethoxylate, wherein the coco-amine ethoxylate and the tallow amine ethoxylate are present, in combination, at a combined weight percent of at least 25 wt % based on a total weight of the glyphosate adjuvant composition. Methods of the present invention may be used to increase the cloud point of a glyphosate composition above about 40° C., and in some embodiments, above about 50° C., and in some embodiments, up to about 80° C.

The present invention is also directed to methods of improving the biological efficacy of a glyphosate composition. In one exemplary embodiment, the method of improving the biological efficacy of a glyphosate composition comprises: incorporating a glyphosate adjuvant composition into a glyphosate composition, the glyphosate adjuvant composition comprising a coco-amine ethoxylate in combination with a tallow amine ethoxylate, wherein the coco-amine ethoxylate and the tallow amine ethoxylate are present, in combination, at a combined weight percent of at least 25 wt % based on a total weight of the glyphosate adjuvant composition.

The present invention is also directed to methods of improving the freeze-thaw performance of a glyphosate composition. In one exemplary embodiment, the method of improving the freeze-thaw performance of a glyphosate composition comprises: incorporating a glyphosate adjuvant composition into a glyphosate composition, the glyphosate adjuvant composition comprising a coco-amine ethoxylate in combination with a tallow amine ethoxylate, wherein the coco-amine ethoxylate and the tallow amine ethoxylate are present, in combination, at a combined weight percent of at least 25 wt % based on a total weight of the glyphosate adjuvant composition.

The present invention is further directed to damaging or killing unwanted plants. In one exemplary embodiment, the method of damaging or killing unwanted plants comprises: applying a glyphosate composition onto or in the vicinity of the unwanted plants, the glyphosate composition comprising (i) a glyphosate adjuvant composition comprising a coco-amine ethoxylate in combination with a tallow amine ethoxylate, wherein the coco-amine ethoxylate and the tallow amine ethoxylate are present, in combination, at a combined weight percent of at least 25 wt % based on a total weight of the glyphosate adjuvant composition, and (ii) glyphosate or a glyphosate salt (e.g., potassium glyphosate).

The above summary was intended to summarize certain embodiments of the present disclosure. Methods, compositions and products will be set forth in more detail, along with examples demonstrating efficacy, in the detailed description below. It will be apparent, however, that the detailed description is not intended to limit the present invention, the scope of which should be properly determined by the appended claims.

### DETAILED DESCRIPTION

The present invention is directed to glyphosate adjuvant compositions comprising a coco-amine ethoxylate in combination with a tallow amine ethoxylate, wherein the coco-amine ethoxylate and the tallow amine ethoxylate are present, in combination, at a combined weight percent of at least 25 wt % based on a total weight of the glyphosate adjuvant composition. Typically, the coco-amine ethoxylate and the tallow amine ethoxylate are present, in combination, at a combined weight percent of at least 50 wt % based on a total weight of the glyphosate adjuvant composition. In some desired embodiments, the coco-amine ethoxylate and the tallow amine ethoxylate are present, in combination, at a combined weight percent of from about 60.1 wt % to about 75.0 wt % based on a total weight of the glyphosate adjuvant composition.

Further, the coco-amine ethoxylate and the tallow amine ethoxylate are typically present at a coco/tallow weight ratio of from about 1:2 to about 2:1. In some embodiments, the coco-amine ethoxylate and the tallow amine ethoxylate are present at a coco/tallow weight ratio of from about 1:2 to about 1:1. In other embodiments, the coco-amine ethoxylate and the tallow amine ethoxylate are present at a coco/tallow weight ratio of from about 1.17:1.

Suitable coco-amine ethoxylates for use in the glyphosate adjuvant compositions of the present invention include, but are not limited to, coco-amine ethoxylates having an average degree of ethoxylation of from about 2 to about 15 (or any degree of ethoxylation from about 2 to about 15). Exemplary commercially available coco-amine ethoxylates for use in the glyphosate adjuvant compositions of the present invention include, but are not limited to, coco-amine ethoxylates sold by Stepan Company (Northfield, IL <www.stepan.com>) under the trade designation TOXIMUL®, such as TOXIMUL® CA-2. TOXIMUL® CA-2 is an ethoxaylated coco-amine with an approximately 2 Moles of EO. Other examples of suitable coco-amine ethoxylates for use in the glyphosate adjuvant compositions of the present invention include Toximul® CA-7.5 (Stepan), Genamin® C020 (Clariant <www.clariant.com>), Genamin® C050 (Clariant), Genamin® C200 (Clariant), Ethomeen® C/12 (AkzoNobel <www.akzonobel.com>) and Ethomeen® C/25 (AkzoNobel),

Suitable tallow amine ethoxylates for use in the glyphosate adjuvant compositions of the present invention include, but are not limited to, tallow amine ethoxylates having an average degree of ethoxylation of from about 2 to about 20 (or any average degree of ethoxylation from about 2 to about 15 in increments of 1). Exemplary commercially available tallow amine ethoxylates for use in the glyphosate adjuvant compositions of the present invention include, but are not limited to, tallow amine ethoxylates sold by Stepan Company (Northfiled, Ill.) under the trade designation TOXIMUL®, such as TOXIMUL® TA-8.¹ TOXIMUL® TA-8 is an ethoxaylated tallow amine with an approximately 8 Moles of EO. Other examples of suitable tallow-amine ethoxylates for use in the glyphosate adjuvant compositions of the present invention include (Toximul® TA-2 (Stepan), Toximul® TA-15 (Stepan), Rhodameen® TA-15 (Rhodia), Genamin® T100 (Clariant), Genamin® T250 (Clariant) and, Ethomeen® T/25 (Akzo Nobel) ¹ Provide other suitable tallow amine ethoxylates here if desired.

The glyphosate adjuvant compositions of the present invention may further comprise one or more additional components. In some embodiments, the glyphosate adjuvant compositions of the present invention further comprise an amine oxide. When present, the amine oxide is typically present in an amount of less than 50 wt % based on a total weight of the glyphosate adjuvant composition. In some embodiments, the amine oxide is present in an amount of from about 15.0 wt % to about 38.0 wt % based on a total weight of the glyphosate adjuvant composition. In one exemplary embodiment, the amine oxide is present in an amount from about 20 to about 30 wt %. In one exemplary embodiment, the amine oxide is present in an amount of about 25 to about 35 wt % based on a total weight of the glyphosate adjuvant composition.

Suitable amine oxides for use in the glyphosate adjuvant compositions of the present invention include, but are not limited to, amine oxides comprising an unsaturated alkyl chain having from about 6 to about 20 carbon atoms therein (or any number of carbon atoms between about 6 and about 20). The amine oxide can have a saturated or unsaturated carbon chain, can have a branched or linear carbon chain, can be naturally derived (e.g. coco or tallow derivative) or synthetically derived, can be ethoxylated (e.g. from 2 to 20 moles ethoxylation) or non-ethoxylated. Amine oxides are of the general formula R₃N→O, and are commonly tertiary amines. Amine oxide having the general formula:

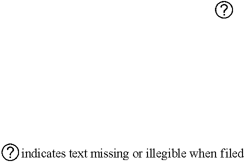

Where R¹, R² and R³ are independently hydrogen or hydrocarbon side chains. Exemplary commercially available amine oxides for use in the glyphosate adjuvant compositions of the present invention include, but are not limited to, amine oxides sold by Stepan Company (Northfield, Ill.) under the trade designation AMMONYX®, such as AMMONYX® LO (e.g., a lauramine oxide). AMMONYX® LO, for example, is of the formula:

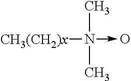

wherein x is predominantly 11. Other examples of suitable amine oxides include Ammonyx® DO, Ammonyx® MO, Ammonyx® CO, Ammonyx® SO (all Stepan), Rhodamox® LO, Mackamine® LO (Rhodia), Aromox® MCD-W, Aromox® C/12, Aromox® DMC, Aromox® DM16, Aromox® DMHT, Aromox® T/12 DEG, (all Akzo Nobel), Genaminox® LA, Genamin® CHE (Clariant)

In some embodiments, the glyphosate adjuvant compositions of the present invention further comprise a quaternary ammonium surfactant (also referred to herein as a “quat”). When present, the quaternary ammonium surfactant is typically present in an amount of less than 50 wt % based on a total weight of the glyphosate adjuvant composition. In some exemplary embodiments, the quaternary ammonium surfactant is present in an amount of from about 25.0 wt % to about 35.0 wt % based on a total weight of the glyphosate adjuvant composition. In one exemplary embodiment, the quaternary ammonium surfactant is present in an amount of about 33.33 wt % based on a total weight of the glyphosate adjuvant composition.

Suitable quaternary ammonium surfactants for use in the glyphosate adjuvant compositions of the present invention include, but are not limited to, quaternary ammonium surfactants comprising an unsaturated alkyl chain having from about 6 to about 20 carbon atoms therein (or any number of carbon atoms between about 6 and about 20). The quaternary ammonium surfactant can have a saturated or unsaturated carbon chain, can have a branched or linear carbon chain, can be naturally derived (e.g. coco or tallow derivative) or synthetically derived, can be ethoxylated (e.g. from 2 to 20 moles ethoxylation) or non-ethoxylated. Quaternary ammounium cations are of the general formula NR₄⁺ (also shown below), with R being an alkyl group or aryl group.

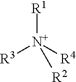

Exemplary commercially available quaternary ammonium surfactants for use in the glyphosate adjuvant compositions of the present invention include, but are not limited to, quaternary ammonium surfactants sold by Stepan Company (Northfiled, Ill.) under the trade designation AMMONYX®, such as AMMONYX® CETAC (e.g., hexadecyl(trimethyl)azanium chloride). AMMONYX® CETAC, for example, is of the formula:

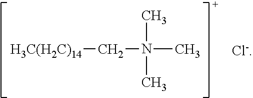

Other examples of suitable quaternary ammonium surfactants include Genamin® CTAC and CTAC 50 (Clariant), Arquad® 16-29, Arquad® C-33W, Ethoquad® O/12PG, Ethoquad® C/25, Ethoquad® T/25, Duoquad® T-50 (all Akzo Nobel).

In some embodiments of the present invention, the glyphosate adjuvant composition further comprises a water-miscible solubilizer. When present, the water-miscible solubilizer is typically present in an amount of from about 5.0 wt % to about 30.0 wt % based on a total weight of the glyphosate adjuvant composition. In one exemplary embodiment, the water-miscible solubilizer is present in an amount of about 10.18 wt % based on a total weight of the glyphosate adjuvant composition.

Suitable water-miscible solubilizers for use in the glyphosate adjuvant compositions of the present invention include, but are not limited to, water-miscible solubilizers comprising propylene glycol, polyethylene glycol, glycerol, ethylene glycol, alkyl polysaccharides (e.g., alkyl polyglycosides), pentoses and high fructose corn syrup, or a combinations thereof.

The present invention is further directed to glyphosate compositions comprising (i) any one of the herein disclosed glyphosate adjuvant compositions, and (ii) glyphosate or a glyphosate salt. In one exemplary embodiment, glyphosate compositions of the present invention comprise (i) a glyphosate adjuvant composition comprising: a coco-amine ethoxylate in combination with a tallow amine ethoxylate, wherein the coco-amine ethoxylate and the tallow amine ethoxylate are present, in combination, at a combined weight percent of at least 25 wt % (or at least 50 wt %, or at least 60 wt %) based on a total weight of the glyphosate adjuvant composition, and (ii) glyphosate or a glyphosate salt.

The glyphosate compositions of the present invention typically comprise glyphosate or a glyphosate salt in an acid equivalent amount of about 25 to about 50 wt % glyphosate acid equivalent, preferably about 35 to about 45 wt %, most preferably about 36 to about 42 wt %.

Suitable glyphosate salts for use in the glyphosate compositions of the present invention include, but are not limited to, potassium glyphosate, ammonium glyphosate, diammonium glyphosate, isopropylamine glyphosate, dimethylamine, monoethanolamine, diethanolamine, triethanolamine, trimethylsulphonium and mixtures thereof

The glyphosate compositions of the present invention may further comprise one or more additional components. Suitable additional components include, but are not limited to, water, an antifoaming agent, one or more additional pesticides, one or more additional surfactants, thickening agents, anti-oxidants, biocides, biostats and any combinations thereof. In some embodiments, the glyphosate compositions of the present invention further comprise water. When present, water is typically present in an amount of from about 3.0 wt % to about 50.0 wt % based on a total weight of the glyphosate composition.

The present invention is further directed to methods of making glyphosate adjuvant compositions and glyphosate compositions. In one exemplary embodiment, the method of making a glyphosate adjuvant composition comprises: combining a coco-amine ethoxylate with a tallow amine ethoxylate so that the combined weight percent of the coco-amine ethoxylate and the tallow amine ethoxylate is at least 25 wt % based on a total weight of the glyphosate adjuvant composition. The method of making a glyphosate adjuvant composition may further comprise one or more additional steps including, but not limited to, adding an amide oxide to the glyphosate adjuvant composition, adding a quartenary ammonium surfactant to the glyphosate adjuvant composition, adding a water-miscible solubilizer to the glyphosate adjuvant composition, mixing/blending/stirring/agitating the glyphosate adjuvant composition, packaging the glyphosate adjuvant composition, storing the glyphosate adjuvant composition, or any combination thereof.

Methods of making a glyphosate composition comprise adding glyphosate or a glyphosate salt to any one of the herein described glyphosate adjuvant compositions. The method of making a glyphosate composition may further comprise one or more additional steps including, but not limited to, adding water to the glyphosate composition, adding an antifoaming agent to the glyphosate composition, adding one or more additional pesticides (e.g., a fungicide, a herbicide, etc.) to the glyphosate composition, mixing/blending/stirring/agitating the glyphosate composition, packaging the glyphosate composition, storing the glyphosate composition, or any combination thereof.

It has been discovered that the herein described glyphosate adjuvant compositions result in glyphosate compositions that provide one or more benefits when compared to known glyphosate adjuvant compositions. As shown in the examples below, the herein described glyphosate adjuvant compositions may result in glyphosate compositions that have one or more benefits compared to known glyphosate adjuvant compositions: (1) improved rainfastness, (2) a relatively higher cloud point, (3) improved biological efficacy, and/or (4) improved freeze-thaw properties.

Consequently, the present invention is directed to methods of improving the rainfastness of a glyphosate composition. In one exemplary embodiment, the method of improving the rainfastness of a glyphosate composition comprises: incorporating a glyphosate adjuvant composition into a glyphosate composition, the glyphosate adjuvant composition comprising any one of the herein described glyphosate adjuvant compositions.

The present invention is also directed to methods of improving the cloud point of a glyphosate composition. In one exemplary embodiment, the method of improving the cloud point of a glyphosate composition comprises: incorporating a glyphosate adjuvant composition into a glyphosate composition, the glyphosate adjuvant composition comprising any one of the herein described glyphosate adjuvant compositions. In some embodiments, the methods may be used to increase the cloud point of a glyphosate composition above about 40° C., and in some embodiments, above about 50° C., and in some embodiments, from about 60° C. to about 80° C.

The present invention is also directed to methods of improving the biological efficacy of a glyphosate composition. In one exemplary embodiment, the method of improving the biological efficacy of a glyphosate composition comprises: incorporating a glyphosate adjuvant composition into a glyphosate composition, the glyphosate adjuvant composition comprising any one of the herein described glyphosate adjuvant compositions.

The present invention is also directed to methods of improving the freeze-thaw performance of a glyphosate composition. In one exemplary embodiment, the method of improving the freeze-thaw performance of a glyphosate composition comprises: incorporating a glyphosate adjuvant composition into a glyphosate composition, the glyphosate adjuvant composition comprising any one of the herein described glyphosate adjuvant compositions.

The present invention is further directed to damaging or killing unwanted plants. In one exemplary embodiment, the method of damaging or killing unwanted plants comprises: applying a glyphosate composition onto or in the vicinity of the unwanted plants, the glyphosate composition comprising (i) any one of the herein described glyphosate adjuvant compositions, and (ii) glyphosate or a glyphosate salt (e.g., potassium glyphosate). In some embodiments, the method of damaging or killing unwanted plants comprises applying the glyphosate composition onto the unwanted plants.

### Other Embodiments

Glyphosate Adjuvant Compositions:

1. A glyphosate adjuvant composition comprising: a coco-amine ethoxylate in combination with a tallow amine ethoxylate, wherein said coco-amine ethoxylate and said tallow amine ethoxylate are present, in combination, at a combined weight percent (wt %) of at least 25 wt % (or any weight percent above 25 wt %, in increments of 0.1 wt %, up to about 95 wt %, or any range of weight percents from above 25 wt % to about 95.0 wt % (e.g., from about 50.0 wt % to about 75.0 wt %), in increments of 0.1 wt %)) based on a total weight of said glyphosate adjuvant composition.

2. The glyphosate adjuvant composition of embodiment 1, wherein said coco-amine ethoxylate and said tallow amine ethoxylate are present, in combination, at a combined weight percent of at least 50 wt % (or any weight percent above 50 wt %, in increments of 0.1 wt %, up to about 95 wt %, or any range of weight percents from above 50 wt % to about 95.0 wt % (e.g., from about 60.0 wt % to about 75.0 wt %)) based on a total weight of said glyphosate adjuvant composition.

3. The glyphosate adjuvant composition of embodiment 1 or 2, wherein said coco-amine ethoxylate and said tallow amine ethoxylate are present, in combination, at a combined weight percent of from about 60.1 wt % to about 75.0 wt % based on a total weight of said glyphosate adjuvant composition.

4. The glyphosate adjuvant composition of any one of embodiments 1 to 3, wherein said coco-amine ethoxylate and said tallow amine ethoxylate are present, in combination, at a combined weight percent of from about 61.2 wt % to about 65.0 wt % based on a total weight of said glyphosate adjuvant composition.

5. The glyphosate adjuvant composition of any one of embodiments 1 to 4, wherein said coco-amine ethoxylate and said tallow amine ethoxylate are present, in combination, at a combined weight percent of from about 61.37 wt % based on a total weight of said glyphosate adjuvant composition.

6. The glyphosate adjuvant composition of any one of embodiments 1 to 5, wherein said coco-amine ethoxylate and said tallow amine ethoxylate are present at a coco/tallow weight ratio of from about 1:2 to about 2:1 (or any weight ratio between 1:2 and 2:1, in increments of 0.01 (e.g., 1.01:1.31), or any range of weight ratio between 1:2 and 2:1, in increments of 0.01 (e.g., from about 1.01:1.31 to about 1.31:1.01)).

7. The glyphosate adjuvant composition of any one of embodiments 1 to 6, wherein said coco-amine ethoxylate and said tallow amine ethoxylate are present at a coco/tallow weight ratio of from about 1:2 to about 1:1 (or any weight ratio between 1:2 and 1:1, in increments of 0.01 (e.g., 1.01:1.31), or any range of weight ratio between 1:2 and 1:1, in increments of 0.01 (e.g., from about 1.01:1.31 to about 1.00:1.00)).

8. The glyphosate adjuvant composition of any one of embodiments 1 to 7, wherein said coco-amine ethoxylate and said tallow amine ethoxylate are present at a coco/tallow weight ratio of from about 1.17:1.

9. The glyphosate adjuvant composition of any one of embodiments 1 to 8, wherein said coco-amine ethoxylate comprises a coco-amine ethoxylate having an average degree of ethoxylation of from about 2 to about 15 (or any average degree of ethoxylation between about 2 and about 15). In a preferred embodiment the average degree of ethoxylation of the coco-amine ethoxylate is from about 2 to about 10, and in another preferred embodiment from about 2-5.

10. The glyphosate adjuvant composition of any one of embodiments 1 to 9, wherein said tallow amine ethoxylate comprises a tallow amine ethoxylate having an average degree of ethoxylation of from about 2 to about 20 (or any average degree of ethoxylation between about 2 and about 15). In a preferred embodiment the average degree of ethoxylation of the tallow-amine ethoxylate is from about 2 to about 10, and in another preferred embodiment from about 5-8.

11. The glyphosate adjuvant composition of any one of embodiments 1 to 10, further comprising an amine oxide.

12. The glyphosate adjuvant composition of any one of embodiments 1 to 11, further comprising an amine oxide present in an amount of less than about 50 wt % (or any weight percent less than about 50 wt %, in increments of 0.1 wt %, down to about 0.1 wt %, or any range of weight percents less than about 50 wt % to about 0.1 wt % (e.g., from about 0.5 wt % to about 25.0 wt %)) based on a total weight of said glyphosate adjuvant composition.

13. The glyphosate adjuvant composition of any one of embodiments 1 to 12, further comprising an amine oxide present in an amount of from about 30.0 wt % to about 38.0 wt % (or any weight percent between about 20.0 wt % to about 25.0 wt %, in increments of 0.1 wt %, or any range of weight percents between about 20.0 wt % to about 35.0 wt % (e.g., from about 23.0 wt % to about 29.0 wt %)) based on a total weight of said glyphosate adjuvant composition.

14. The glyphosate adjuvant composition of any one of embodiments 1 to 13, further comprising an amine oxide present in an amount of about 28 wt % based on a total weight of said glyphosate adjuvant composition.

15. The glyphosate adjuvant composition of any one of embodiments 1 to 14, further comprising an amine oxide, wherein said amine oxide comprises lauramine oxide.

16. The glyphosate adjuvant composition of any one of embodiments 1 to 10, further comprising a quaternary ammonium surfactant.

17. The glyphosate adjuvant composition of any one of embodiments 1 to 10 and 16, further comprising a quaternary ammonium surfactant present in an amount of less than 50 wt % (or any weight percent less than about 50 wt %, in increments of 0.1 wt %, down to about 0.1 wt %, or any range of weight percents less than about 50 wt % to about 0.1 wt % (e.g., from about 0.5 wt % to about 25.0 wt %)) based on a total weight of said glyphosate adjuvant composition.

18. The glyphosate adjuvant composition of any one of embodiments 1 to 10 and 16 to 17, further comprising a quaternary ammonium surfactant present in an amount of from about 25.0 wt % to about 35.0 wt % (or any weight percent between about 25.0 wt % to about 35.0 wt %, in increments of 0.1 wt %, or any range of weight percents between about 25.0 wt % to about 35.0 wt % (e.g., from about 27.5 wt % to about 33.5 wt %)) based on a total weight of said glyphosate adjuvant composition.

19. The glyphosate adjuvant composition of any one of embodiments 1 to 10 and 16 to 18, further comprising a quaternary ammonium surfactant present in an amount of about 30 wt % based on a total weight of said glyphosate adjuvant composition.

20. The glyphosate adjuvant composition of any one of embodiments 1 to 10 and 16 to 19, further comprising a quaternary ammonium surfactant, wherein said quaternary ammonium surfactant comprises hexadecyl(trimethyl)azanium chloride. Hexadecyl(trimethyl)azanium chloride is also commonly referred to as cetyltrimethylammonium chloride or cetriammonium chloride.

21. The glyphosate adjuvant composition of any one of embodiments 1 to 20, further comprising a water-miscible solubilizer.

22. The glyphosate adjuvant composition of any one of embodiments 1 to 21, further comprising a water-miscible solubilizer present in an amount of from about 5.0 wt % to about 30.0 wt % (or any weight percent between about 5.0 wt % to about 30.0 wt %, in increments of 0.1 wt %, or any range of weight percents between about 5.0 wt % to about 30.0 wt % (e.g., from about 5.6 wt % to about 10.5 wt %)) based on a total weight of said glyphosate adjuvant composition.

23. The glyphosate adjuvant composition of any one of embodiments 1 to 22, further comprising a water-miscible solubilizer present in an amount of about 10.18 wt % based on a total weight of said glyphosate adjuvant composition.

24. The glyphosate adjuvant composition of any one of embodiments 1 to 23, further comprising a water-miscible solubilizer, wherein said water-miscible solubilizer comprises propylene glycol.

25. The glyphosate adjuvant composition of any one of embodiments 1 to 23, further comprising a water-miscible solubilizer, wherein said water-miscible solubilizer comprises polyethylene glycol, glycerol, ethylene glycol, alkyl polysaccharides (e.g. alkyl polyglycosides), pentoses and high fructose corn syrup or combinations thereof

Glyphosate Compositions:

26. A glyphosate composition comprising (i) the glyphosate adjuvant composition of any one of embodiments 1 to 25, and (ii) glyphosate or a glyphosate salt.

27. The glyphosate composition of embodiment 26, wherein said glyphosate or glyphosate salt is present in an acid equivalent amount of about 25 to about 50 wt % glyphosate acid equivalent, preferably about 35 to about 45 wt %, most preferably about 36 to about 42 wt %.

28. The glyphosate composition of embodiment 26 or 27, wherein said glyphosate or glyphosate salt is present in an acid equivalent amount of from about 36 wt % to about 42 wt % (or any weight percent between about 36 wt % and about 42 wt %, in increments of 0.1 wt %, or any range of weight percents between about 36 wt % and about 42 wt % (e.g., from about 37.0 wt % to about 39.3 wt %)) based on a total weight of said glyphosate composition.

29. The glyphosate composition of any one of embodiments 26 to 28, wherein said glyphosate salt is present and comprises potassium glyphosate salt.

30. The glyphosate composition of any one of embodiments 26 to 29, further comprising water.

31. The glyphosate composition of embodiment 30, wherein said water is present in an amount of from about 3.0 wt % to about 50.0 wt % (or any weight percent between about 3.0 wt % and about 50.0 wt %, in increments of 0.1 wt %, or any range of weight percents between about 3.0 wt % and about 50.0 wt % based on a total weight of said glyphosate composition.

Methods of Forming Glyphosate Adjuvant Compositions:

32. A method of forming the glyphosate adjuvant composition of any one of embodiments 1 to 25, said method comprising: combining the coco-amine ethoxylate with the tallow amine ethoxylate so that the combined weight percent of the coco-amine ethoxylate and the tallow amine ethoxylate is at least 25 wt % (or any weight percent above 25 wt %, in increments of 0.1 wt %, up to about 95 wt %, or any range of weight percents from above 25 wt % to about 95.0 wt % (e.g., from about 50.0 wt % to about 75.0 wt %) based on a total weight of the glyphosate adjuvant composition.

Methods of Forming Glyphosate Compositions:

33. A method of forming a glyphosate composition, said method comprising: adding glyphosate or a glyphosate salt to the glyphosate adjuvant composition of any one of embodiments 1 to 25.

Methods of Improving Properties/Performance of Glyphosate Compositions:

34. A method of improving the rainfastness of a glyphosate composition, said method comprising: incorporating the glyphosate adjuvant composition of any one of embodiments 1 to 25 into the glyphosate composition.

35. A method of improving the cloud point of a glyphosate composition, said method comprising: incorporating the glyphosate adjuvant composition of any one of embodiments 1 to 25 into the glyphosate composition.

36. The method of embodiment 35, wherein the cloud point of the glyphosate composition is above about 40° C. (or any temperature value above about 40° C., in increments of 0.1° C., or any range of temperature values above about 40° C. (e.g., from about 40.1° C. to about 80.1° C.)).

37. The method of embodiment 35 or 36, wherein the cloud point of the glyphosate composition is above about 50° C. (or any temperature value above about 50° C., in increments of 0.1° C., or any range of temperature values above about 50° C. (e.g., from about 50.1° C. to about 60.8° C.)).

38. The method of any one of embodiments 35 to 37, wherein the cloud point of the glyphosate composition is from about 60° C. to about 80° C. (or any temperature value between about 60° C. and about 80° C., in increments of 0.1° C., or any range of temperature between about 60° C. and about 80° C. (e.g., from about 60.1° C. to about 70.8° C.)).

39. A method of improving the biological efficacy of a glyphosate composition, said method comprising: incorporating the glyphosate adjuvant composition of any one of embodiments 1 to 25 into the glyphosate composition.

40. A method of improving the freeze-thaw performance of a glyphosate composition, said method comprising: incorporating the glyphosate adjuvant composition of any one of embodiments 1 to 25 into the glyphosate composition.

Methods of Damaging or Killing Unwanted Plants:

41. A method of damaging or killing unwanted plants, said method comprising: applying the glyphosate composition of any one of embodiments 26 to 31 onto or in the vicinity of the unwanted plants.

42. The method of embodiment 41, wherein said applying step comprises applying the glyphosate composition onto the unwanted plants.

The following examples are for illustration only, and are in no way intended to limit the scope of the invention.

### EXAMPLE 1

### Preparation of Glyphosate Adjuvant Compositions

The following glyphosate compositions were prepared by mixing the components shown in Table 1 below.

TABLE 1
Glyphosate Compositions

| | Sample 1 | Sample 2 |
|---|---|---|
| INGREDIENT | wt % as added | wt % as added |
| K-glyphosate | 85.69 | 85.69 |
| (46% AE) | | |
| TOXIMUL ® CA-2 | 3.50 | 3.00 |
| TOXIMUL ® TA-8 | 3.00 | 3.00 |
| AMMONYX ® LO | 3.00 | |
| AMMONYX ® CETAC | | 3.00 |
| Antifoam (e.g. | 0.04 | 0.04 |
| Antifoam 1510 from | | |
| Dow Chemical) | | |
| Propylene glycol | 1.00 | 1.00 |
| Water | 3.77 | 4.27 |
| Total | 100 | 100 |

### EXAMPLE 2

### Testing Glyphosate Adjuvant Compositions for Rainfastness

The rainfastness of glyphosate compositions shown in Example 1 (e.g., Sample 1 and 2) was compared to a commercially available glyphosate composition available under the trade designation TOUCHDOWN® TOTAL (Syngenta). Each composition was applied to the following weeds: ABUTH, AMARE, CHEAL, and ECHCG. The rate of application was 560 g ae/ha. Rainfall (i.e., 0.25 inches of rainfall) was provided within the following time periods: 0.5 hour, 1 hour, 2 hours, and no rainfall.

Assessment of the rainfastness, as measured as percent of control (i.e., % Control), was taken at 6-7, 10, 20-21 DAT. The results are shown in Tables 2-3 below:

TABLE 2
Average of ABUTH, CHEAL, ECHCG,
and AMAPA control, 20-21 DAT:

| | TOUCH- | | | % | % |
|---|---|---|---|---|---|
| | DOWN ® | | | Increase | Increase |
| | TOTAL | Sample 1 | Sample 2 | Sample 1 | Sample 2 |
| 0.5 Hour | 42.2 | 55.7 | 55.1 | 32.0% | 30.6% |
| 1 Hour | 54.4 | 67.5 | 60.6 | 24.1% | 11.4% |
| 2 Hours | 52.5 | 69.4 | 71 | 32.2% | 35.2% |
| None | 78.7 | 84.6 | 83.2 | 7.5% | 5.7% |

TABLE 3
ABUTH, CHEAL, ECHCG, and AMAPA control,
in the greenhouse, 7-10 DAT:

| | TOUCH- | | | % | % |
|---|---|---|---|---|---|
| | DOWN ® | | | Increase | Increase |
| | TOTAL | Sample 1 | Sample 2 | Sample 1 | Sample 2 |
| ABUTH | 40 | 57.5 | 45 | 43.8% | 12.5% |
| AMARE | 63.8 | 82.5 | 76.3 | 29.3% | 19.6% |
| CHEAL | 63.8 | 65 | 66.3 | 1.9% | 3.9% |
| ECHCG | 63.8 | 70 | 73.8 | 9.7% | 15.7% |

Greenhouse data surprisingly indicated that novel glyphosate compositions of the present invention (i.e., Samples 1 and 2) provided improved rainfastness over the commercially available glyphosate composition TOUCHDOWN® TOTAL.

### EXAMPLE 3

### Preparation of Glyphosate Compositions and Testing for Cloud Points

The following glyphosate composition of the present invention, referred to herein as “Sample 3”, was prepared by mixing the components shown in Table 4 below.

TABLE 4
Sample 3 Glyphosate Composition Containing Amine Oxide

| | | Actual | Wt % of | |
|---|---|---|---|---|
| | | wt % | individual com- | Wt % of |
| | wt % as | adjuvant | ponents in sur- | Alkoxylated |
| INGREDIENT | added | system | factant system | alkylamines |
| K-glyphosate | 79.35 | | | |
| (46% AE) | | | | |
| TOXIMUL ® CA-2 | 2.2 | 2.2 | 32.93% | |
| TOXIMUL ® TA-8 | 1.9 | 1.9 | 28.44% | 32.93% + |
| | | | | 28.44% = |
| | | | | 61.37% |
| AMMONYX ® LO | 1.9 | 1.9 | 28.44% | |
| Antifoam (e.g. | 0.02 | | | |
| Antifoam 1510 from | | | | |
| Dow Chemical) | | | | |
| Propylene glycol | 0.68 | 0.68 | 10.18% | |
| Water | 13.95 | | | |
| Total | 100% | 6.68% | 100% | |

The following glyphosate compositions were also prepared by mixing the components shown in Table 5 below.

TABLE 5
Glyphosate Compositions

| | SAMPLE No | | | | | |
|---|---|---|---|---|---|---|
| | C1 | 3A | C3 | 3B | C5 | 3C |
| | Actual Wt | Actual Wt | Actual Wt | Actual Wt | Actual Wt | Actual Wt |
| | (g) | (g) | (g) | (g) | (g) | (g) |
| PMGK (46.5%) | 89.9 | 89.9 | 84.8 | 84.8 | 80.8 | 80.8 |
| TOXIMUL ® | 2.8 | | 2.8 | | 2.8 | |
| TA-6 | | | | | | |
| AMMONYX ® | 2.8 | 2.0 | 2.8 | 2.0 | 2.8 | 2.0 |
| LO | | | | | | |
| PEG 200 | 1.4 | | 1.4 | | 1.4 | |
| TOXIMUL ® | | 2.0 | | 2.0 | | 2.0 |
| TA-8 | | | | | | |
| TOXIMUL ® | | 2.3 | | 2.3 | | 2.3 |
| CA2 | | | | | | |
| Propylene glycol | | 0.7 | | 0.7 | | 0.7 |
| Agent 3109-6 | | | | | | |
| Water | 3.1 | 3.1 | 8.2 | 8.2 | 12.2 | 12.2 |
| Total | 100.0 | 100.0 | 100.0 | 100.0 | 100.0 | 100.0 |

Table 6 below describes each composition (i.e., whether the glyphosate composition is of the present invention or representative of prior art glyphosate compositions).

TABLE 6
Glyphosate Composition Description and Cloud Points

| | | Density | | Cloud Point |
|---|---|---|---|---|
| Sample | Description | (g/cm³) | g/L AE | (° C.) |
| C1 | Example 21 on page 18 of WO2009/154772 using | NA | | <25 |
| | 7% surfactant blend A shown in Table 1 on page 16 | | | |
| | (89.9% PMGK) | | | |
| 3A | Sample 3 above using 7% surfactant blend (89.9% | 1.39673 | 584 | 48-53 |
| | PMGK) | | | |
| C3 | Example 21 on page 18 of WO2009/154772 using | 1.37543 | 542 | <25 |
| | 7% surfactant blend A shown in Table 1 on page 16 | | | |
| | (84.8% PMGK) | | | |
| 3B | Sample 3 above using 7% surfactant blend (84.8% | 1.37457 | 542 | 62-66 |
| | PMGK) | | | |
| C5 | Example 21 on page 18 of WO2009/154772 using | 1.35601 | 509 | 30-37 |
| | 7% surfactant blend A shown in Table 1 on page 16 | | | |
| | (80.8% PMGK) | | | |
| 3C | Sample 3 above using 7% surfactant blend (80.8% | 1.35194 | 508 | 69-75 |
| | PMGK) | | | |

Measurement of the key physical property “Cloud Point” indicates that the novel adjuvant systems of the present invention (i.e., Samples 3A, 3B and 3C) surprisingly provide significantly improved cloud points compared to compositions disclosed in the prior art (i.e., compositions disclosed in WO 2009/154772). Generally the “Cloud Point” is the temperature where the formulation begins phase separation and two phases visually appear giving a “cloudy” appearance.

### EXAMPLE 3a

### Preparation of Glyphosate Compositions and Testing for Cloud Points Based on % Tallow Amine Ethoxylate

The following glyphosate compositions, Samples A-G, were prepared by mixing the components showing in Table 6a below.

TABLE 6a

| | Sample No.: | | | | | | |
|---|---|---|---|---|---|---|---|
| | A | B | C | D | E | F | G |
| | Actual | Actual | Actual | Actual | Actual | Actual | Actual |
| Component | Wt (g) | Wt (g) | Wt (g) | Wt (g) | Wt (g) | Wt (g) | Wt (g) |
| PMGK (46%) | 85 | 85 | 85 | 85 | 85 | 85 | 85 |
| TOXIMUL ® TA-8 | 5 | 4 | 3 | 2.5 | 2 | 1 | 0 |
| TOXIMUL ® CA2 | 0 | 1 | 2 | 2.5 | 3 | 4 | 5 |
| Propylene glycol | 0.7 | 0.7 | 0.7 | 0.7 | 0.7 | 0.7 | 0.7 |
| Water | 9.3 | 9.3 | 9.3 | 9.3 | 9.3 | 9.3 | 9.3 |
| Total | 100 | 100 | 100 | 100 | 100 | 100 | 100 |

TABLE 6b

| Sample No. | Cloud Point (° C.) |
|---|---|
| A | <25 (Separation at RT) |
| B | 38-43 |
| C | >80 |
| D | >80 |
| E | >80 |
| F | >80 |
| G | >80 |

From Tables 6, 6a and 6b above, it is surprisingly shown that the addition of the coco amine ethoxylate to the tallow amine ethoxylate significantly increases the cloud point of the formulations while maintaining the herbicidal efficacy known with alkoxylated alkylamine formulations containing only tallow amine ethoxylate (see Table 10 below). In one preferred embodiment the ratio of coco:tallow amine ethoxylate is from about 2:3 to about 4:1. In another preferred embodiment the ratio of coco:tallow amine ethoxylate is from about 2:3 to about 3:2. In another preferred embodiment the ratio of coco:tallow amine ethoxylate is about 1:1.

### EXAMPLE 4

### Preparation of Glyphosate Compositions and Testing for Biological Efficacy

The following glyphosate compositions were prepared by mixing the components shown in Table 7 below.

TABLE 7
Glyphosate Compositions

| | Sample 4 | Sample 5 | Sample 6 | Sample 7 |
|---|---|---|---|---|
| Component | Wt % | Wt % | Wt % | Wt % |
| K-Glyphosate | 79.35 | 79.35 | 79.35 | 79.35 |
| (46% AE) | | | | |
| Toximul TA-8 | 1.9 | 1.5 | 1.9 | 1.5 |
| Toximul CA-2 | 2.2 | 1.75 | 1.9 | 1.5 |
| Ammonyx LO | 1.9 | 1.5 | 0 | 0 |
| Ammonyx Cetac | 0 | 0 | 1.9 | 1.5 |
| Propylene glycol | 0.68 | 0.54 | 0.68 | 0.54 |
| Water | 12.41 | 13.97 | 14.27 | 15.61 |
| Total | 100 | 100 | 100 | 100 |
| Total wt % | 6.68% | 5.29% | 6.38% | 5.58% |
| Surfactant | | | | |

Samples 4-7 and TOUCHDOWN® TOTAL (Syngenta) were tested for biological efficacy on broadleaf weeds shown in Table 8 and grass weeds shown in Table 9 below. Each composition was applied at 500 g ae/ha, and evaluated 13-21 DAT. Results are shown in Tables 10-11 below.

TABLE 8
Broadleaf Weeds

| Code | Scientific Name | Common Name |
|---|---|---|
| ABUTH | Abutilon theophrasti | Velvetleaf |
| AMAPA | Amaranthus palmeri | Palmer amaranth |
| AMARE | Amaranthus retroflexus | Redroot pigweed |
| AMATA | Amaranthus rudis | Common waterhemp |
| AMBTR | Ambrosia trifida | Giant ragweed |
| AMATU | Amaranthus tuberculatum | Tall waterhemp |
| CASOB | Cassia obtusifolia | Sicklepod |
| CHEAL | Chenopodium album | Lambsquarters |
| DEDTO | Desmodium tortuosum | Florida beggarweed |
| HIBTR | Hibiscus trionum | Venice mallow |
| IAQTA | Jacquemontia tamnifolia | Smallflower morningglory |
| IPOHE | Ipomoea hederacea var int. | Entireleaf morningglory |
| IPOLA | Ipomoea lacunosa | Pitted morningglory |
| KCHSC | Kochia scoparium | Kochia |
| MEDSA | Medicago sativa | Alfalfa |
| MOLVE | Mollugo verticillata | Carpetweed |
| POLPY | Polygonum pensylvanicum | Pennsylvania smartweed |
| PORPI | Portulaca pilosa | Pink purselane |
| SIDSP | Sida spinosa | Prickly sida |
| SOLSA | Solanum sarrachoides | Hairy nightshade |
| XANST | Xanthium strumarium | Common cocklebur |

TABLE 9
Grass Weeds

| Code | Scientific Name | Common Name |
|---|---|---|
| BRAPP | Brachiaria platyphylla | Broadleaf signalgrass |
| DIGSA | Digitaria sanguinalis | Large crabgrass |
| DTTAE | Dactyloctenium aegyptium | Crowfootgrass |
| ECHCG | Echinochloa crus-galli | Barnyardgrass |
| PANTE | Panicum texanum | Texas panicum |
| SETFA | Setaria faberi | Giant foxtail |
| SETSS | Setaria sp. | Foxtail species |
| SETVI | Setaria viridis | Green foxtail |

TABLE 10
Biological Efficacy (% control) at 13-21 DAT

| | TOUCH- | | | | |
|---|---|---|---|---|---|
| | DOWN ® | | | | |
| | TOTAL | Sample 4 | Sample 5 | Sample 6 | Sample 7 |
| AMATA | 100 | 100 | 100 | 97 | 98 |
| CASOB | 98 | 100 | 97 | 96 | 99 |
| DEDTO | 100 | 100 | 100 | 100 | 100 |
| IAQTA | 100 | 100 | 100 | 100 | 100 |
| MOLVE | 100 | 100 | 100 | 100 | 100 |
| PORPI | 93 | 91 | 87 | 99 | 88 |
| XANST | 98 | 97 | 97 | 98 | 98 |
| AMARE | 81 | 87 | 84 | 73 | 81 |
| CHEAL | 82 | 71 | 82 | 87 | 81 |
| POLPY | 82 | 86 | 80 | 100 | 84 |
| SIDSP | 93 | 77 | 95 | | 97 |
| AMATU | 85 | 90 | 79 | 83 | 76 |
| ABUTH | 76 | 78 | 80 | 73 | 81 |
| AMAPA | 73 | 76 | 75 | 71 | 76 |
| IPOLA | 73 | 77 | 76 | 76 | 71 |

TABLE 11
Biological Efficacy (% control) at 13-21 DAT

| | TOUCH- | | | | |
|---|---|---|---|---|---|
| | DOWN ® | | | | |
| | TOTAL | Sample 4 | Sample 5 | Sample 6 | Sample 7 |
| AMBTR | 75 | 78 | 82 | | 75 |
| AMAPA* | 79 | 67 | 76 | 77 | 75 |
| HIBTR | | 73 | 63 | 65 | 70 |
| IPOHE | 71 | 69 | 68 | 65 | 65 |
| KCHSC | 47 | 58 | 55 | 57 | 57 |
| SOLSA | 43 | 50 | 50 | 43 | 50 |
| MEDSA | 37 | 43 | 43 | 37 | 47 |
| SETFA | 100 | 100 | 100 | 99 | 100 |
| BRAPP | 97 | 95 | 95 | 97 | 98 |
| DTTAE | 99 | 95 | 94 | 96 | 88 |
| DIGSA | 90 | 88 | 89 | 91 | 90 |
| SETVI | 85 | 87 | 88 | 87 | 85 |
| SETSS | 90 | 80 | 92 | 88 | 85 |
| ECHCG | 80 | 77 | 79 | 79 | 78 |
| PANTE | 68 | 70 | 72 | 67 | 63 |

Samples 4-7 were equally as efficacious as the commercially available standard TOUCHDOWN® TOTAL glyphosate composition.

### EXAMPLE 5

### Preparation of Glyphosate Compositions and Testing for Biological Efficacy

The following glyphosate compositions were prepared by mixing the components shown in Table 12 below.

TABLE 12
Glyphosate Compositions

| | Sample 8 | Sample 9 |
|---|---|---|
| INGREDIENT | wt % | wt % |
| K-glyphosate | 79.35% | 79.35% |
| (46% AE) | | |
| TOXIMUL ® TA-8 | 1.90% | 1.90% |
| TOXIMUL ® CA-2 | 2.20% | 1.90% |
| AMMONYX ® LO | 1.90% | 0 |
| AMMONYX ® CETAC | 0 | 1.90% |
| Propylene glycol | 0.68% | 0.68% |
| Water | 13.97% | 14.27% |
| Total | 100.00% | 100.00% |
| Total wt % Surfactant | 6.68% | 6.38% |

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range.

It is further noted that, as used in this specification, the singular forms “a,” “an,” and “the” include plural referents unless expressly and unequivocally limited to one referent.

It should be understood that although the above-described glyphosate adjuvant compositions, glyphosate compositions, and methods are described as “comprising” one or more components or steps, the above-described glyphosate adjuvant compositions, glyphosate compositions, and methods may “comprise,” “consists of,” or “consist essentially of” any of the above-described components, features or steps of the glyphosate adjuvant compositions, glyphosate compositions, and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a glyphosate adjuvant compositions and/or method that “comprises” a list of elements (e.g., components, features or steps) is not necessarily limited to only those elements (or components or steps), but may include other elements (or components or steps) not expressly listed or inherent to the composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a glyphosate adjuvant composition, a glyphosate composition, and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A glyphosate adjuvant composition comprising:
a coco-amine ethoxylate, or sythenic form thereof;
a tallow amine ethoxylate, or sythenic form thereof; and
an amine oxide, wherein said coco-amine ethoxylate and said tallow amine ethoxylate are present, in combination, at a combined weight percent (wt %) of at least 25 wt % based on a total weight of said glyphosate adjuvant composition.

2. The glyphosate adjuvant composition of claim 1, wherein said coco-amine ethoxylate and said tallow amine ethoxylate are present, in combination, at a combined weight percent of at least 50 wt % based on a total weight of said glyphosate adjuvant composition.

3. The glyphosate adjuvant composition of claim 1, wherein said coco-amine ethoxylate and said tallow amine ethoxylate are present, in combination, at a combined weight percent of from about 60.1 wt % to about 75.0 wt % based on a total weight of said glyphosate adjuvant composition.

4. The glyphosate adjuvant composition of claim 1, wherein said coco-amine ethoxylate and said tallow amine ethoxylate are present, in combination, at a combined weight percent of from about 61.2 wt % to about 65.0 wt % based on a total weight of said glyphosate adjuvant composition.

5. The glyphosate adjuvant composition of claim 1, wherein said coco-amine ethoxylate and said tallow amine ethoxylate are present, in combination, at a combined weight percent of from about 61.37 wt % based on a total weight of said glyphosate adjuvant composition.

6. The glyphosate adjuvant composition of claim 1, wherein said coco-amine ethoxylate and said tallow amine ethoxylate are present at a coco/tallow weight ratio of from about 1:2 to about 2:1.

7. The glyphosate adjuvant composition of claim 6, wherein said coco-amine ethoxylate and said tallow amine ethoxylate are present at a coco/tallow weight ratio of from about 1:2 to about 1:1.

8. The glyphosate adjuvant composition of claim 1, wherein said coco-amine ethoxylate and said tallow amine ethoxylate are present at a coco/tallow weight ratio of from about 2:3 to about 3:2.

9. The glyphosate adjuvant composition of claim 1, wherein said coco-amine ethoxylate comprises a coco-amine ethoxylate having an average degree of ethoxylation of from about 2 to about 5.

10. The glyphosate adjuvant composition of claim 1, wherein said tallow amine ethoxylate comprises a tallow amine ethoxylate having an average degree of ethoxylation of from about 5 to about 8.

11. The glyphosate adjuvant composition of claim 10, further comprising an amine oxide present in an amount of less than 50 wt % based on a total weight of said glyphosate adjuvant composition.

12. The glyphosate adjuvant composition of claim 11, further comprising an amine oxide present in an amount of from about 30.0 wt % to about 38.0 wt % based on a total weight of said glyphosate adjuvant composition.

13. The glyphosate adjuvant composition claim 12, further comprising an amine oxide present in an amount of about 28 wt % based on a total weight of said glyphosate adjuvant composition.

14. The glyphosate adjuvant composition of claim 1, further comprising an amine oxide, wherein said amine oxide comprises lauramine oxide.

15. The glyphosate adjuvant composition of claim 1, further comprising a quaternary ammonium surfactant.

16. The glyphosate adjuvant composition of claim 1, further comprising a quaternary ammonium surfactant present in an amount of less than 50 wt % based on a total weight of said glyphosate adjuvant composition.

17. The glyphosate adjuvant composition of claim 16, further comprising a quaternary ammonium surfactant present in an amount of from about 25.0 wt % to about 35.0 wt % based on a total weight of said glyphosate adjuvant composition.

18. The glyphosate adjuvant composition of claim 16, further comprising a quaternary ammonium surfactant, wherein said quaternary ammonium surfactant comprises hex adecyl(trimethyl)azanium chloride.

19. A method of improving the cloud point of a glyphosate composition, said method comprising:
incorporating the glyphosate adjuvant composition of claim 1 into the glyphosate composition.

20. The method of claim 19, wherein the cloud point of the glyphosate composition is above about 40° C.
